(19) United States
(12) Patent Application Publication
(10) Pub. No.: US 2015/0242817 A1
(43) Pub. Date: Aug. 27, 2015

(54) SHARING RECRUITING INFORMATION

(71) Applicant: Vittal Srimushnam, Cupertino, CA (US)

(72) Inventor: Vittal Srimushnam, Cupertino, CA (US)

(21) Appl. No.: 14/189,626

(22) Filed: Feb. 25, 2014

(51) Int. Cl. G06Q 10/10; H04L 12/58; H04L 12/18

(52) U.S. Cl. CPC G06Q 10/1053; H04L 12/1813; H04L 51/32

(57) ABSTRACT

A method of sharing recruiting information involves storing network rules defining a private network among member entities; receiving a request to publish a subset of the recruiting information managed by a first member to other members of the private network; applying the network rules to the subset of the recruiting information managed by the first member to determine a publishable set of recruiting information, and publishing the publishable set of recruiting information to the other members of the private network; receiving a request to expose to the first member a subset of the recruiting information managed by another member for consideration as a match for the publishable set of recruiting information; and applying the network rules to the subset of the recruiting information managed by the other member to determine an exposable set of recruiting information, and exposing the exposable subset of the recruiting information to the first member.

### BACKGROUND

The present invention relates to employment recruiting (or simply “recruiting”) and, more particularly, to systems and methods for sharing recruiting information.

Recruiting involves finding qualified candidates for open employment positions. Recruiters may attempt to match available candidates from within the recruiters' own organizations or rely on external resources, such as primary job boards (e.g., Dice, Monster, and Career Builder), secondary job boards (e.g., free job boards, such as those offered by Universities and Craig's List), social networks (e.g., LinkedIn), career portals embedded in their own websites, and peer recruiting firms.

Over the years, recruiters have developed a complex communication system that leverages web and electronic mail (“email”) based communication platforms to match requirements in one organization with available candidates in other organizations and vice versa. In this regard, web based job boards have become the primary intermediaries between recruiters and candidates, whereas electronic mail has become the primary mode of communication for exchanging “requirements lists” of job requirements and “hot lists” of candidate attributes among recruiters. Job boards aggregate candidate information for recruiters and allow candidates to better position themselves for new opportunities, but charge recruiters to make their requirements visible to candidates and to permit recruiters to access candidates' information. With respect to electronic mail, recruiters do not know in advance which of their contacts can provide a match for their job requirements and hot list candidates and therefore would prefer, in many cases, to indiscriminately broadcast their job requirements and hot lists; but such an approach is constrained by anti-spamming rules, which require recruiters to tailor their broadcasts to specific audiences.

Improved systems and methods for sharing recruiting information are needed.

### DESCRIPTION OF DRAWINGS

FIG. 1 is a diagrammatic view of an example of a network communications environment

FIG. 2 is a block diagram of an example of a client network node.

FIG. 3 is a flow diagram of an example of a method of sharing recruiting information.

FIG. 4 is a diagrammatic view of an example of a graphical user interface.

FIG. 5 is a diagrammatic view of an example of a graphical user interface.

FIG. 6 is a diagrammatic view of an example of a graphical user interface.

FIG. 7 is a diagrammatic view of an example of a graphical user interface.

FIG. 8 is a diagrammatic view of an example of a graphical user interface.

FIG. 9 is a diagrammatic view of an example of a graphical user interface.

FIG. 10 is a diagrammatic view of an example of a graphical user interface.

FIG. 11 is a diagrammatic view of an example of a graphical user interface.

FIG. 12 is a diagrammatic view of an example of a graphical user interface.

FIG. 13 is a diagrammatic view of an example of a graphical user interface.

FIG. 14 shows an example of a ranking table.

FIG. 15 is a diagrammatic view of an example of client network nodes sharing recruiting information over a private network.

FIG. 16 is a flow diagram of an example of a method of sharing recruiting information.

FIG. 17 is a diagrammatic view of an example of a graphical user interface showing information describing candidate progress through a job candidate pipeline for a job requirement.

FIG. 18 is a diagrammatic view of an example of information exchanged between members of a private network.

FIG. 19 is a diagrammatic view of an example of information exchanged between members of a private network.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

### I. DEFINITION OF TERMS

A “computer” is any machine, device, or apparatus that processes data according to computer-readable instructions that are stored on a computer-readable medium either temporarily or permanently. A “computer operating system” is a software component of a computer system that manages and coordinates the performance of tasks and the sharing of computing and hardware resources. A “software application” (also referred to as software, an application, computer software, a computer application, a program, and a computer program) is a set of instructions that a computer can interpret and execute to perform one or more specific tasks. A “data file” is a block of information that durably stores data for use by a software application.

The term “computer-readable medium” (also referred to as “memory”) refers to any tangible, non-transitory medium capable storing information (e.g., instructions and data) that is readable by a machine (e.g., a computer). Storage devices suitable for tangibly embodying such information include, but are not limited to, all forms of physical, non-transitory computer-readable memory, including, for example, semiconductor memory devices, such as random access memory (RAM), EPROM, EEPROM, and Flash memory devices, magnetic disks such as internal hard disks and removable hard disks, magneto-optical disks, DVD-ROM/RAM, and CD-ROM/RAM.

A “network node” (also referred to simply as a “node”) is a physical junction or connection point in a communications network. Examples of network nodes include, but are not limited to, a terminal, a computer, and a network switch. A “server node” is a network node that responds to requests for information or service. A “client node” is a network node that requests information or service from a server node.

The terms “registered user” and “member” are used interchangeably herein to refer to persons who are permitted to use the information sharing service described herein.

As used herein, the term “includes” means includes but not limited to, the term “including” means including but not limited to. The meaning of the term “based on” encompasses “based at least in part on”.

### II. SHARING RECRUITING INFORMATION

A. Introduction

The systems and methods that are described herein provide a recruiting information sharing platform that registers recruiters and candidates as members and allows these members to communicate within the confines of the platform. This approach can eliminate uncertainty of electronic mail broadcasters and receivers, reduce delays in communication, enhance the richness of the information shared, and reduce the volume of communications sent and received. For example, the platform provides administering control mechanisms (e.g., “opt-outs” and “opt-ins”) amongst registered recruiters and between registered recruiters and registered candidates that allow both registered recruiters and registered candidates to explicitly retain control of their information and relationships. The platform also provides a uniform method of characterizing requirements and candidates throughout the recruiting supply chain to enable registered recruiters to match requirements and candidates with higher precision and shorter cycle times at a much lower cost.

In some examples, the recruiting information sharing platform also includes a set of one or more services that enables registered recruiters to establish configurable private networks amongst themselves to exchange and match job requirements to candidates and vice versa with agreed upon levels of transparency that reflect their respective levels of comfort in exchanging information with the other members of the private network.

B. System Overview

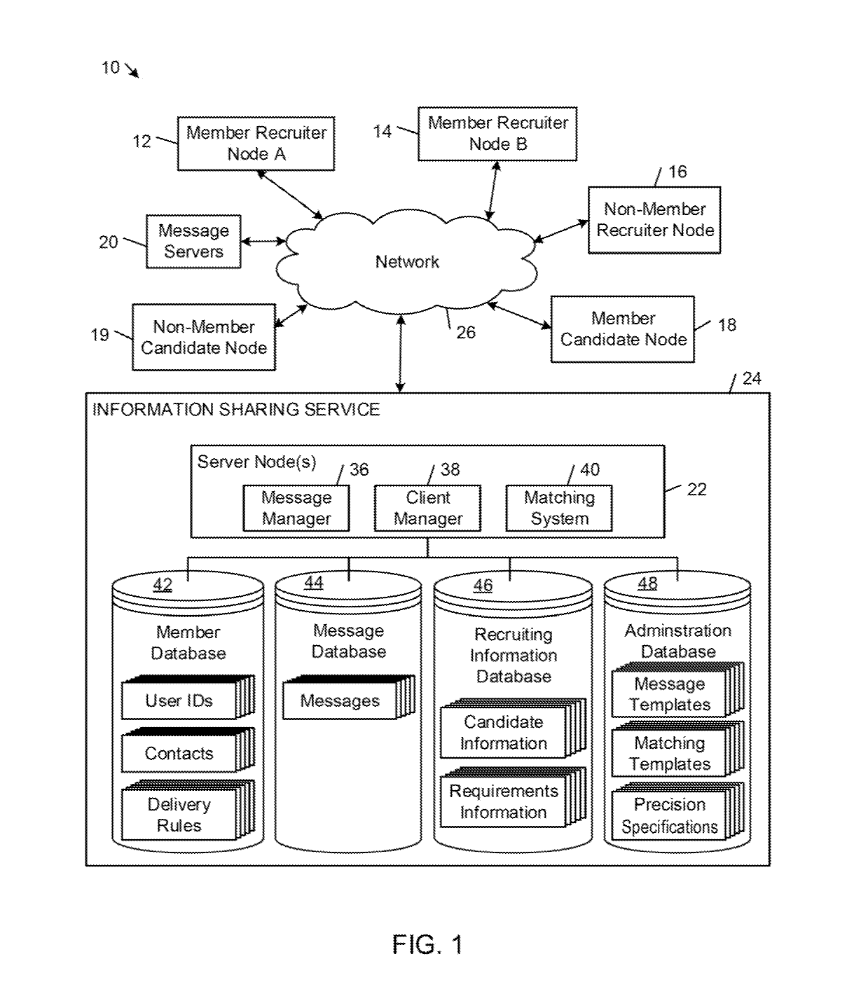

FIG. 1 shows an example of a network communications environment 10 that includes a first client node 12 (Member Recruiter Node A), a second client node 14 (Member Recruiter Node B), a third client node 16 (Non-Member Recruiter Node), a fourth client node 18 (Member Candidate Node), a fifth client node 19 (Non-Member Candidate Node), one or more message servers 20, and at least one server node 22 that provides an information sharing service 24 that supports communications between the client nodes 12-18. The nodes 12-22 are interconnected by a network 26 that includes, for example, any of a local area network (LAN), a metropolitan area network (MAN), and a wide area network (WAN) (e.g., the internet).

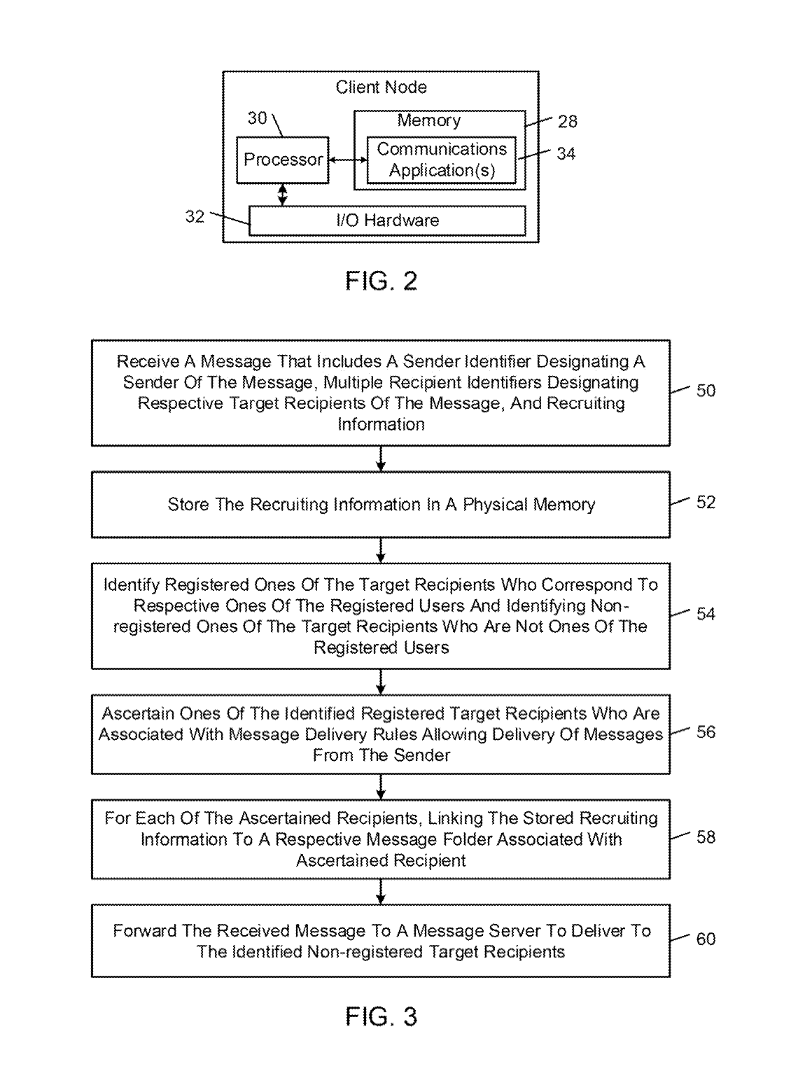

As shown in FIG. 2, each of the client nodes 12-19 typically includes a tangible, non-transitory computer-readable memory 28, a processor 30, and input/output (I/O) hardware (including a display) 32. The processor 30 executes at least one communications application 34 that is stored in the memory 28. The server node 22 typically is implemented with similar hardware components as the client nodes 12-19, including a computer-readable memory, a processor, and input/output (I/O) hardware.

Referring back to FIG. 1, the server node 22 runs a variety of different server applications (including, e.g., a message manager application 36, a client manager application 38, and a matching system application 40) that collectively provide the information sharing service 24. The message manager application 28 manages the handling of messages sent by and addressed to registered users of the information sharing service 24. The client manager application 30 interfaces registered users with the information sharing service 24. In some examples, the client manager application 30 provides a web client interface for web browser applications running on the client network nodes of registered users to interact with the information sharing service 24. The matching system application 40 matches requirements to candidates and candidates to requirements for registered users of the information sharing service 24. In the illustrated example, the information sharing service 24 is a message sharing service that supports the exchange of asynchronous messages (e.g., electronic mail messages) between the client nodes 12-18. In other examples, the information sharing service 20 also supports one or more types of synchronous communications between the client nodes 12, 14 (e.g., instant messaging (e.g., text chat), audio conferencing, video conferencing, application sharing, and file sharing).

In the process of implementing the information sharing service 24, the server applications 36-40 operate on a variety of different data, including data stored in, for example, a member database 42, a message database 44, a recruiting information database 46, and an administration database 48.

The members database 42 stores member-specific information, including user identifiers (IDs), contact information, and delivery rules. In some examples, the user identifiers are electronic mail addresses of the registered users. Such electronic mail addresses typically consist of a local name (e.g., a user name) and a domain name that are joined by an at sign (i.e., “@”). In some examples, the registered users' electronic mail addresses have domain names that identify one or more of the message servers 20 that transfer electronic mail messages for the information sharing service 24. The contact information includes electronic mail addresses of individual contacts and bulk mailing lists of such contacts that have been uploaded or otherwise provided by the registered users of the information sharing service 24. The delivery rules specify how incoming communications should be handled for each registered user of the information sharing service 24; these rules include gating rules (e.g., opt-in and out-out rules) that control whether incoming communications are blocked or presented to registered users, and filtering rules which control the delivery of unblocked messages to specific message folders of the registered users.

The message database 44 stores messages sent by and addressed to registered users of the information sharing service 24. Each message typically includes multiple components. For example, an electronic mail message typically includes a message header, a message body, and one or more attachments (e.g., tokens that include recruiting information, such as candidate information and job requirements information, and matching criteria as described below). In some examples, for each bulk message that is addressed to multiple registered users, the message manager application 36 stores only a single copy of the message in physical memory and links each registered user addressee to the stored copy of message. In this way, the message manager application 36 eliminates redundant messages and thereby conserves storage space and streamlines the message delivery process.

The recruiting information database 46 stores recruiting information, including candidate information and job requirements information. The candidate information typically includes “values” (e.g., attribute field entries) for a variety of attributes for each job candidate, including a name, home address information, work location preference information, current availability, expected compensation information, and job experience information (e.g., total experience and skills). The requirements information typically includes a variety of attributes for each job, including a requirement title, a description of the job (e.g., a job title, a list of required skills, job location, job duration, the number of job openings, compensation information), and contact information. The recruiting information may be uploaded or otherwise entered by registered users of the information sharing service 24 through the client manager application 38 or may be extracted from incoming messages by the message manager application 36 (e.g., by analyzing tokens that are attached to the messages, as described below). The recruiting information is used by the matching system application 40 to identify potential matches between candidates and requirements for registered users of the information sharing service 24.

The administration database 48 stores administrative information, including message templates, matching templates, matching precision specifications, and private network templates. The message templates are managed by the client manager application 38 and include predefined and user customized templates for creating outgoing messages to recruiters or candidates. The matching templates are managed by the matching system application 40. Each matching template defines a standard set of job requirement attributes and is associated with one or more matching-precision-dependent designations of a respective subset of the defined job requirements attributes that are mandatory for matching purposes. The matching precision specifications are managed by the matching system application 40 and define different levels of matching precision for matching requirement attributes with corresponding candidate attributes. In some examples, for each of the possible attributes of a particular type of job requirement, there is a respective matching precision specification that defines specific criteria for matching the requirement attribute value with a corresponding job candidate attribute value. The private network templates define standard sets of rules and transparency settings for different types of private networks.

C. Message Handling

Registered users of the information sharing service 24 may send outgoing recruiting messages to other members and to non-members of the information sharing service 24 in a variety of different ways. In some examples, the client manager application 38 provides access to a messaging system (e.g., a web interface) that enables registered users to prepare a recruiting message and designate members of different groups of target recipients to which to send the recruiting message. In other examples, registered users send recruiting messages from a specialized recruiting management system (e.g., an applicant tracking system (ATS) or a vendor management system (VMS)) that communicates with the information sharing service 24 through an application programming interface (API).

FIG. 3 shows a flow diagram of a method by which the message manager application 36 handles outgoing messages that are sent by registered users of the information sharing service 24.

In accordance with the method of FIG. 3, the message manager application 36 receives a message that includes a sender identifier designating a sender of the message, multiple recipient identifiers designating respective target recipients of the message, and recruiting information (FIG. 3, block 50). The message manager application 36 stores the recruiting information in a physical memory (FIG. 3, block 52). The message manager application 36 identifies registered ones of the target recipients who correspond to respective ones of the registered users and identifies non-registered ones of the target recipients who are not ones of the registered users (FIG. 3, block 54). The message manager application 36 ascertains ones of the identified registered target recipients who are associated with message delivery rules allowing delivery of messages from the sender (FIG. 3, block 56). For each of the ascertained recipients, the message manager application 36 links the stored recruiting information to a respective message folder that is associated with ascertained recipient (FIG. 3, block 58). The message manager application 36 forwards the received message to a message server for delivery to the identified non-registered target recipients (FIG. 3, block 60).

In some examples, a communications application running on the client node of a registered user of the information sharing service 24 includes a message grabber (e.g., by means of a plug-in or a built-in feature) that analyzes the messages received by the communications application to identify recruiting messages, and forwards the identified messages to the information sharing service 24 through an API. Upon receipt of a message from the message grabber, the message manager application 36 stores the message in the physical member and provides a link to the addressee. If the message manager application 36 receives multiple copies of the same message from respective message grabbers running on different client nodes, the message manager application 36 stores only a single copy of the message and links the stored message copy to a respective message folder of each of the corresponding registered users.

D. User Interface

1. User Settings

As mentioned above, the client manager application 30 interfaces registered users with the information sharing service 24. In the examples illustrated below, the client manager application 30 provides a web client interface for web browser applications running on the client network nodes of registered users to interact with the information sharing service 24.

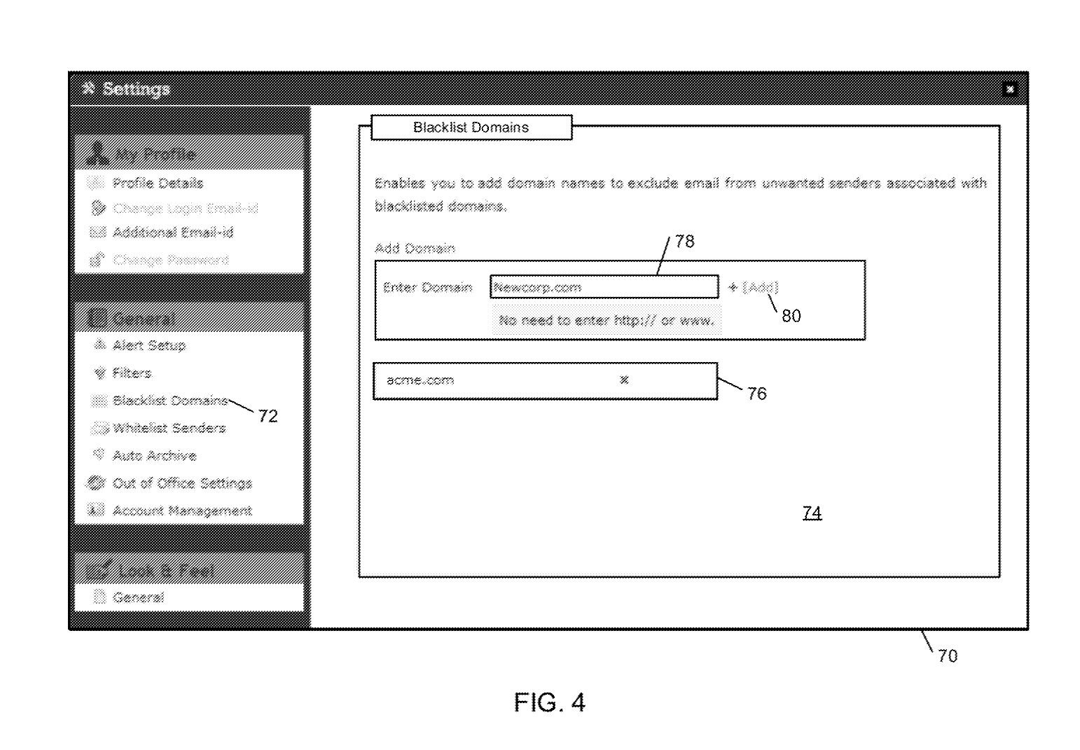

FIG. 4 shows an example of a Settings interface 70 that allows a registered user to manage various user settings, including gating rules (e.g., opt-in and out-out rules) that control whether incoming communications are blocked or presented to registered users, and filtering rules that control the delivery of unblocked messages to specific message folders of the registered users.

In response to user selection of a Blacklist Domains control 72, the client manager application 30 presents the user with a Blacklist Domains pane 74 that allows the user to add domain names to a blacklist 76 that will be used by the message manager application 36 to block electronic mail from any senders who are associated with any of the domains in the blacklist 76. The user can add a domain name (e.g., Newcorp.com) to the blacklist 76 by entering the domain name in a text box 78 and clicking the Add button 80.

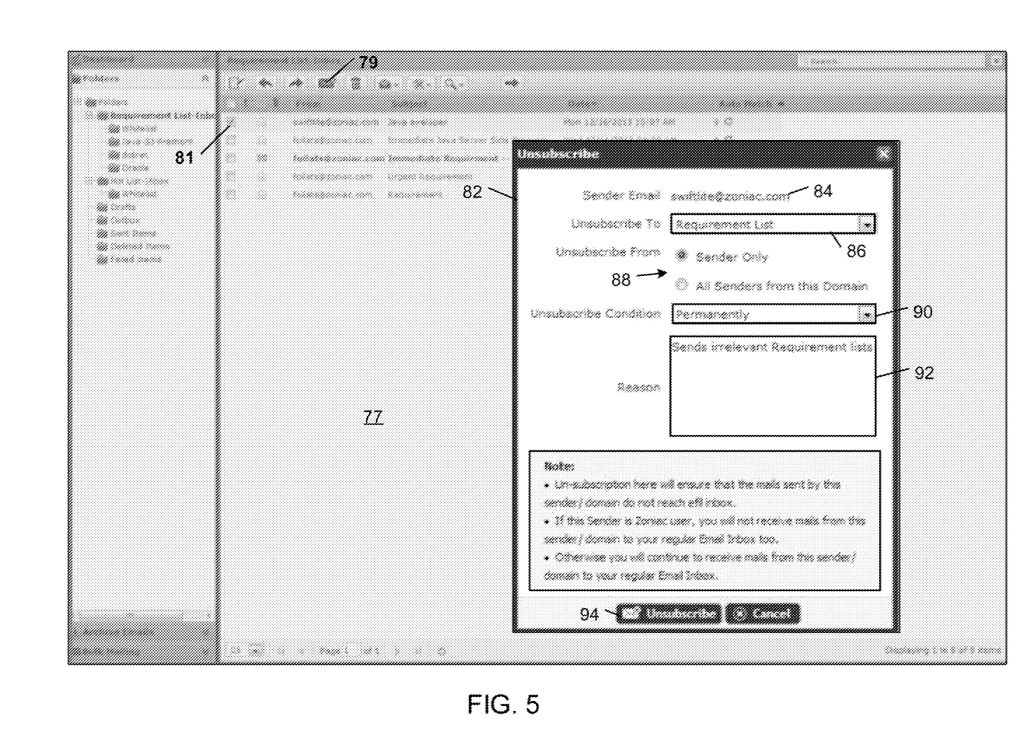

Referring to FIG. 5, the client manager application 30 also allows users to block electronic mail messages sent by senders who are associated with particular electronic mail addresses or particular domain names while reviewing electronic mail messages in a message pane 77. In response to user selection of an Opt-Out control 79 in connection with an electronic mail message 81 that was received from a particular sender (e.g., swiftlite@zoniac.com), the client manager application 30 presents the user with an Unsubscribe interface 82 that displays the electronic mail address 84 of the particular sender and presents options for defining an opt-out filter for blocking incoming messages sent by the particular sender that are addressed to the user. The Unsubscribe interface 82 includes: a dropdown list 86 that allows the user to apply the opt-out filter to requirements list messages, hot list messages, or both; controls 88 that allow the user to apply the opt-out filter to block the receipt of the designated message types sent by the particular sender or sent by any senders in the domain (e.g., zoniac.com) corresponding to the particular sender's electronic mail address; and a dropdown list 90 that allows the user to specify the duration of the opt-out filter (e.g., permanently, one month, one week, etc.). The Unsubscribe interface 82 also includes a text box 92 that allows the user to specify a reason for blocking electronic mail messages of the designated message type sent by the specified sender or senders. In some example, the client manager application 30 may notify each sender that messages sent by the sender to the user are being blocked and the notification optionally may include the reason specified by the user.

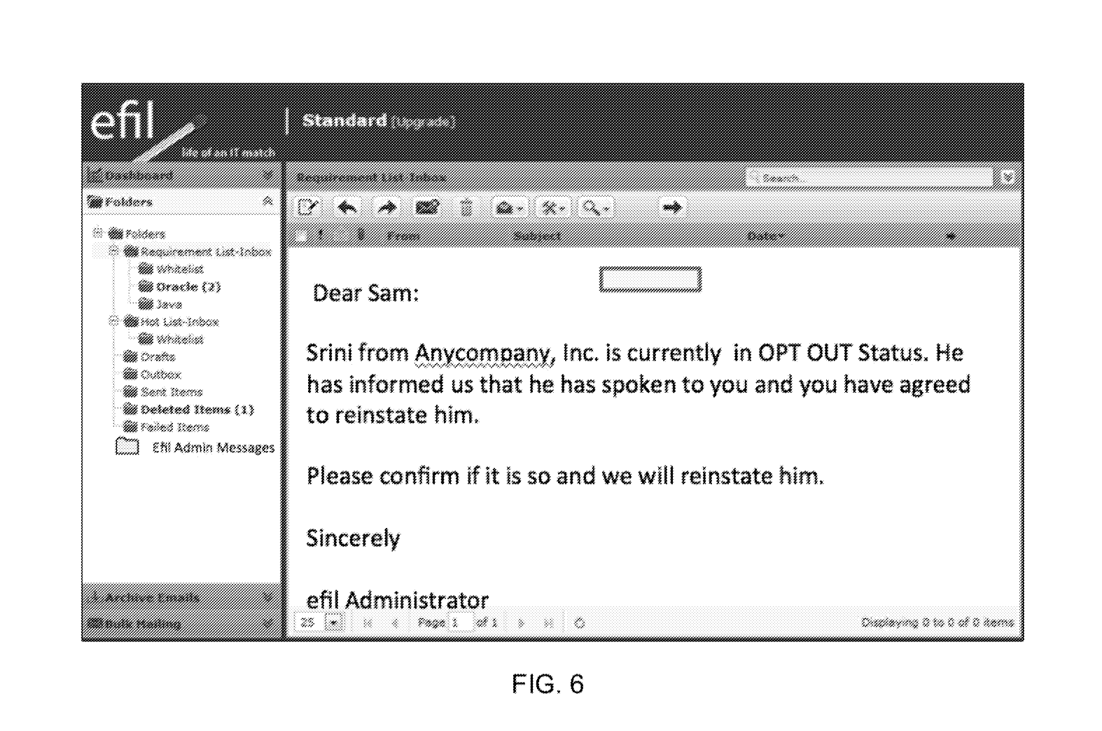

If a user has blacklisted or opted-out of receiving messages from a particular sender (or requires the permission of the receiving member to access a private network, as described below), the user has to “opt-in” before any requirements or hot lists from the particular sender are permitted to be delivered to the user. The opt-in process is initiated when the blocked sender sends the information sharing service 24 a request to allow messages from the blocked sender to be delivered to the unsubscribed user. In response to such a request, the information sharing service 24 may send the user a message of the type shown in FIG. 6 that allows the user to opt-in and thereby allow messages sent by the blocked sender to be delivered to the user.

Links to electronic mail messages that are not blocked are delivered to the inbox folders of the target recipients according to filters that are associated with the inbox folders. Each named folder in a user's inbox is associated with a set of one or more matching filters that must be satisfied by the attributes of an electronic mail message in order for the stored message to be linked to the folder. In some examples, each member is allowed to create a predetermined number of message filters and only a predetermined number of those message filters, chosen by the member, is permitted to be active on any given day.

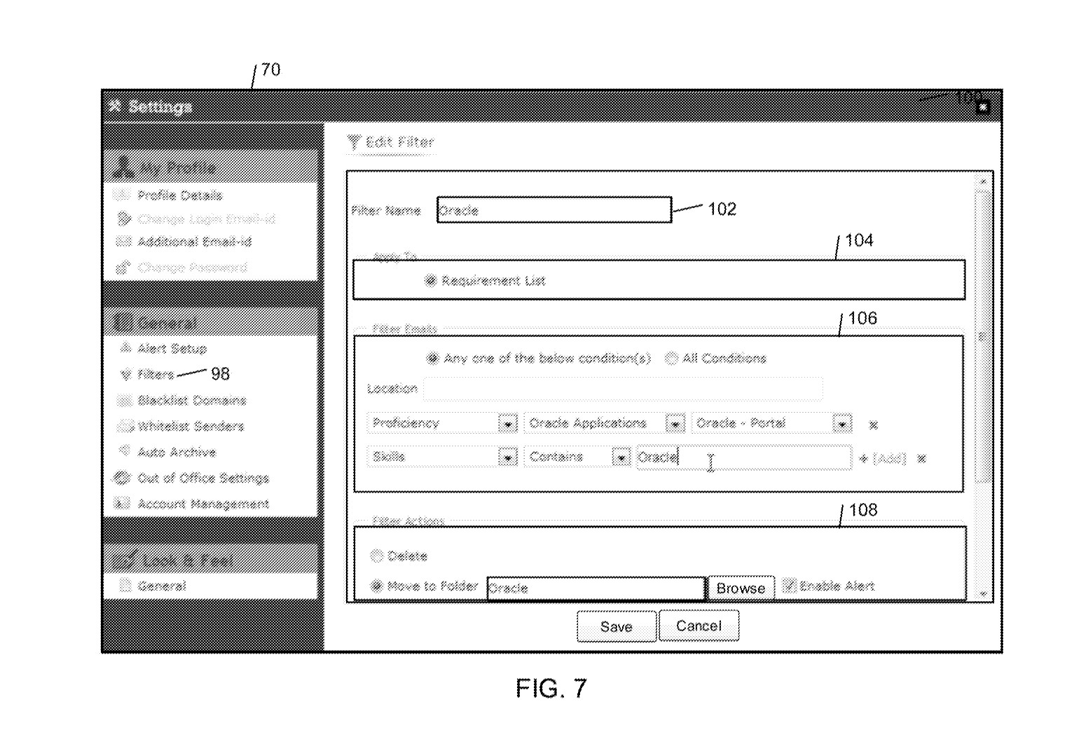

Referring to FIG. 7, in response to user selection of a Filters control 98 in the Settings User interface 70, the client manager application 36 presents an Edit Filter interface 100 that allows a user to create a message filter. The Edit Filter interface 100 includes a Filter Name text box 102 for entering a name for the filter, an Apply To section that includes an input control 104 that allows the user to specify the type of message (e.g., Requirement List or a Hot list) that matches the filter, a conditions section 106 that allows the user to specify one or more conditions on attribute values of an incoming message that must be satisfied in order for the message to match the filter, and a Filter Actions section 108 that allows the user to specify how incoming messages that match the filter should be handled (e.g., delete or move to a particular one of the user's inbox folders).

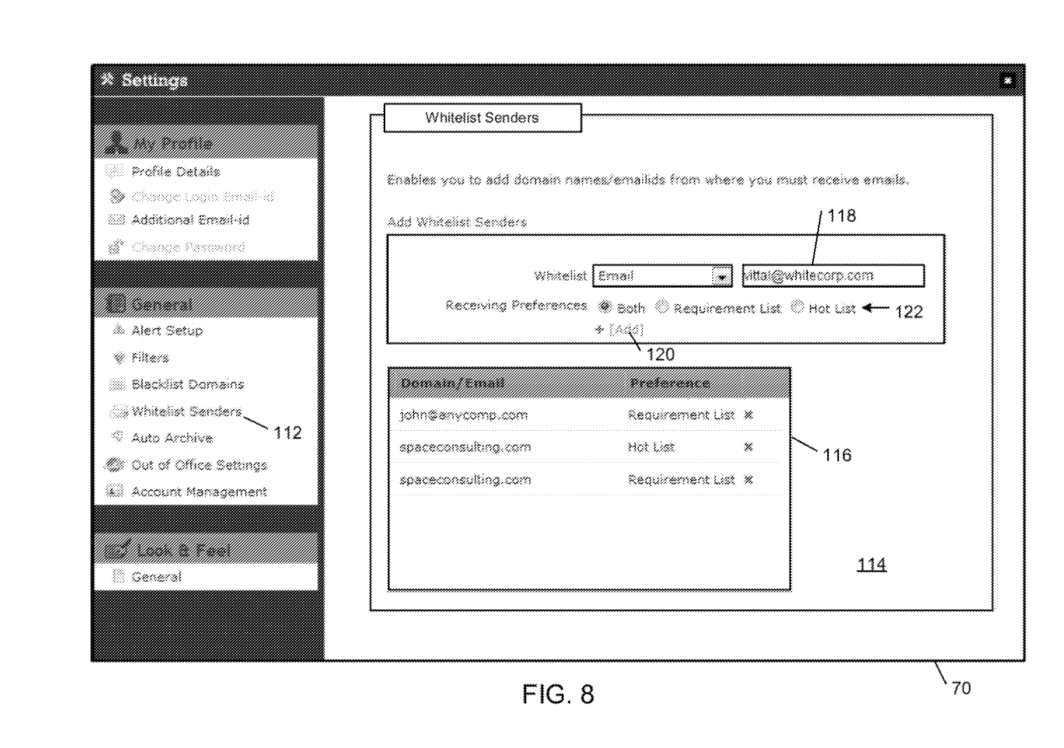

Referring to FIG. 8, in response to user selection of a Whitelist Senders control 112 in the Settings User interface 70, the user is presented with a Whitelist Domains pane 114 that allows the user to add electronic mail addresses and domain names to a whitelist 116. The message manager application 36 provides links to electronic mail messages from any senders who are associated with the electronic mail addresses or domain names in the whitelist 116 in the user's Whitelist message folder without passing through any other filter. The user can add an electronic mail address (e.g., vittal@whitecorp.com) or a domain name (e.g., whitecorp.com) to the whitelist by entering the electronic mail address or domain name in a text box 118 and clicking the Add button 120. In this process, the user may select a respective one or the controls 122 to indicate whether the entered electronic mail address or domain name should be in added to the whitelist 116 for filtering electronic mail messages relating to requirements or hot lists or both requirements and hot lists.

2. Sending Requirements

The client manager application 30 also provides a web client interface that allows registered users to send requirements to recruiters and candidates.

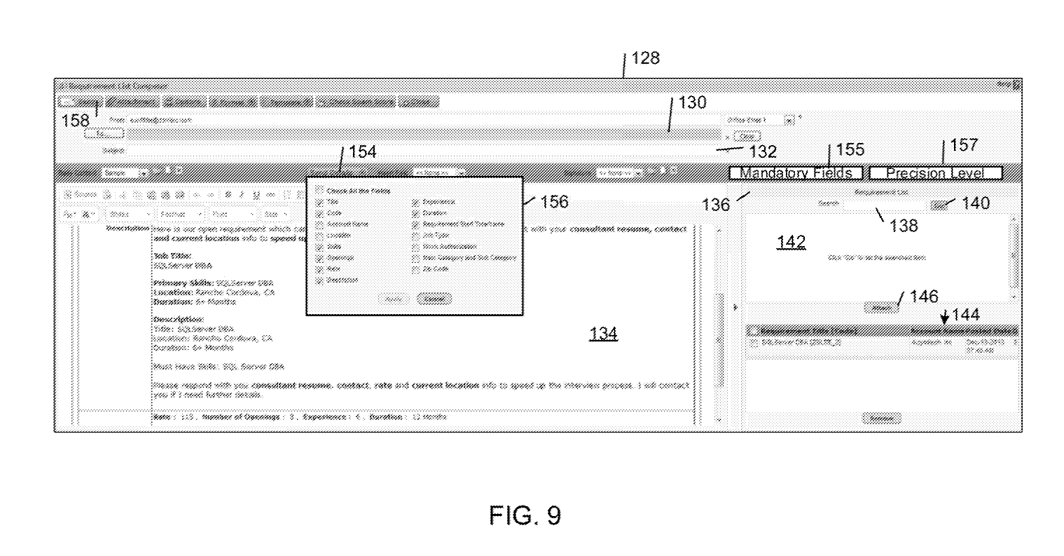

FIG. 9 shows a Requirement List Composer interface 128 that allows the user to compose a requirement list that can be sent with an electronic mail message to recipients designated by the user (e.g., recipients in a bulk mailing list). The Requirement List Composer interface 128 includes a recipients field 130 for receiving one or more target recipient electronic mail addresses, a subject field 132 for receiving a description of the subject of the electronic mail message, a message content section 134 that includes the message body, and a requirement list section 136 that allows the user to find and select an existing requirement (e.g., a requirement that the user previously uploaded or created) from which the requirement list will be generated for the message. In response to entry of one or more search terms in a search box 138 and selection of the Go button 140, the client manager 30 searches for any existing requirements in the recruiting information database 46 that match the search terms and displays the matching requirements in a results box 142. The user may select one of the displayed requirements for association with the electronic mail message by clicking the Attach button 146.

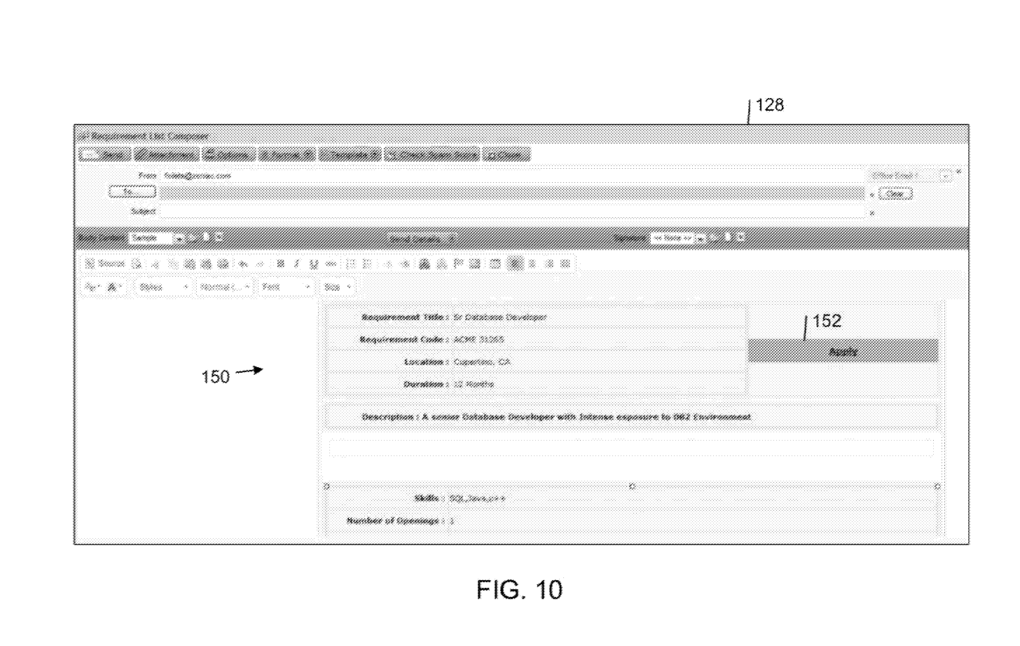

In some examples, the client manager application 30 also allows the user to create a new requirement by entering requirement details in a standard requirement template 150, an example of which is shown in FIG. 10. A standard requirement template includes a predefined list of requirement fields for receiving requirement information from the user that will be used to populate requirement fields in the body of the electronic mail message. In the illustrated example, the standard requirement template 150 includes job attribute fields that allow the user enter the following information: a Requirement Title; a Requirement Code; a Location of the job; a Duration of the job; a Description of the job; a list of the Skills needed for the job; and a Number of Openings for the job. In response to user selection of the Apply button 152, the client manager application 30 creates a new requirement from the entered data and associates the new requirement with the electronic mail message.

After a requirement has been selected for the electronic mail message, the user defines a respective “token” for the requirement by selecting one of several predefined sets of mandatory fields for the requirement from a dropdown list 155 and by selecting a matching precision level (also referred to herein as a “ranking mode”) for the requirement from a dropdown list 157. As used herein, a “token” refers to the combination of (i) a set of mandatory matching fields (e.g., proficiency, location, and experience) that must be present in the requirements list and will be sent with the electronic mail message, and (ii) a set of predefined levels of matching precision (e.g., Normal, High, and Exact), where each matching precision level defines specific matching criteria for matching a respective one of the fields in the requirement with the corresponding hot list field characterizing a job candidate. The matching fields and matching criteria are used by the matching system application 40 to match hot list candidates with job requirements, as explained below. In some examples, the client manager application 30 enables the user to select a set of matching fields from a hierarchical set of matching templates having an identical set of matching fields and different respective numbers of required matching fields. The client manager application 30 also allows the user to select one of several sets of matching precision settings that define different levels of precision for matching the requirement attributes to corresponding candidate hot list fields.

For each requirement level, the information sharing service 24 defines different levels of matching precision. For example, the Candidate Location (zip code) requirement field may be associated with the following precision levels:
Normal Precision: Candidate Location “anywhere”
High Precision: Candidate Location within 75 miles of Job Location
Exact Precision: Candidate Location within 30 miles of Job Location
   In some examples, the default matching precision is set automatically to the Normal Precision level, and the user can select a different precision level manually. In some examples, the user is able to select the matching precision levels for the mandatory matching fields, and the system automatically selects the default Normal precision level to the other matching fields.

Referring back to FIG. 9, the Requirement List Composer interface 128 includes a Send Details control 154 that displays a list 156 of the job requirement fields that will be included in the body of the electronic mail message according to the token associated with the designated requirement. The user may check or uncheck one or more of the fields to change the default set of requirement fields that will be included in the body of the electronic mail message.

After the user enters the recipient electronic mail addresses in the recipients field 130, enters a subject description in the Subject field 132, selects a requirement, and selects a token (i.e., mandatory fields and precision level) for the requirement, the user may select a Send button 158 in the Requirement List Composer interface 128 to send the electronic mail message to the designated recipients.

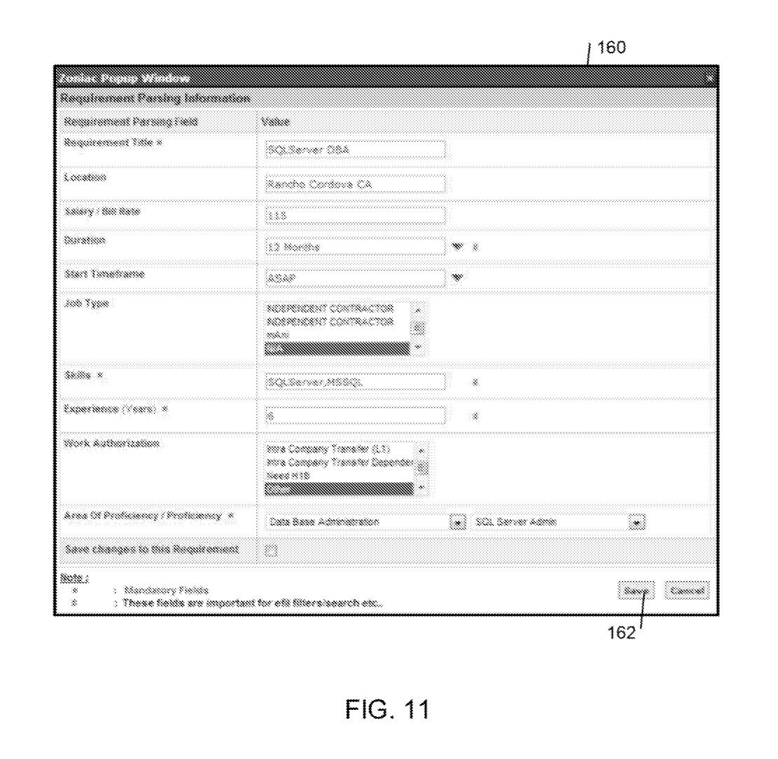

Referring to FIG. 11, in response to user selection of the Send button 158 in the Requirement List Composer interface 128, the client manager application 30 parses the fields of the selected requirement and displays a list of the parsed data in a Requirement Parsing Information window 160. In the illustrated example, the requirement has the following fields: Requirement Title; Location; Salary/Bill Rate; Duration; Start Timeframe; Job Type; Skills; Experience; Work Authorization; and Area of Proficiency/Proficiency. In this example, only the following ones of the fields of the requirement are mandatory: Requirement Title; Skills; Experience; and Area of Proficiency/Proficiency. Before sending the electronic mail message, the client manager application 30 determines whether any the mandatory fields is empty; if any of the mandatory fields is empty, the client manager application 30 will require the user to enter data in each of the empty mandatory fields before allowing the electronic mail message to be sent. The user can review the parsed information in the Requirement Parsing Information window 160 and add information to, modify information in, or delete information from any of the requirement fields (e.g., enter the required information in any of the mandatory fields that are empty). In response to user selection of the Save button 162, the client manager application 30 saves any changes that were made to the requirement field values and reflects those changes in the list of requirements that are copied into the body of the electronic mail message before sending the message to the designated message recipients.

3. Sending Hot Lists

The client manager application 30 also provides a web client interface that allows registered users to send hot lists to recruiters. A hot list is an electronic mail message that includes attributes of one or more candidates (e.g., Name, a list of Skills, Experience, Current Location, Availability, Resume Title, etc.).

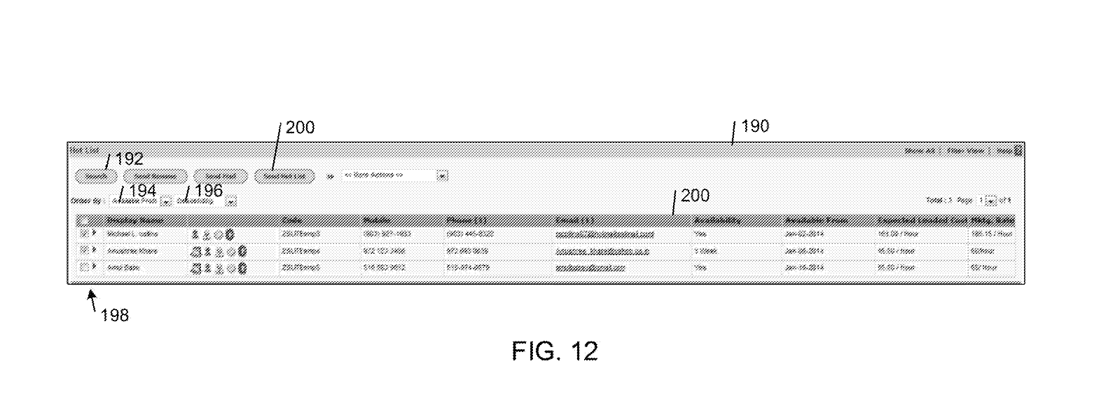

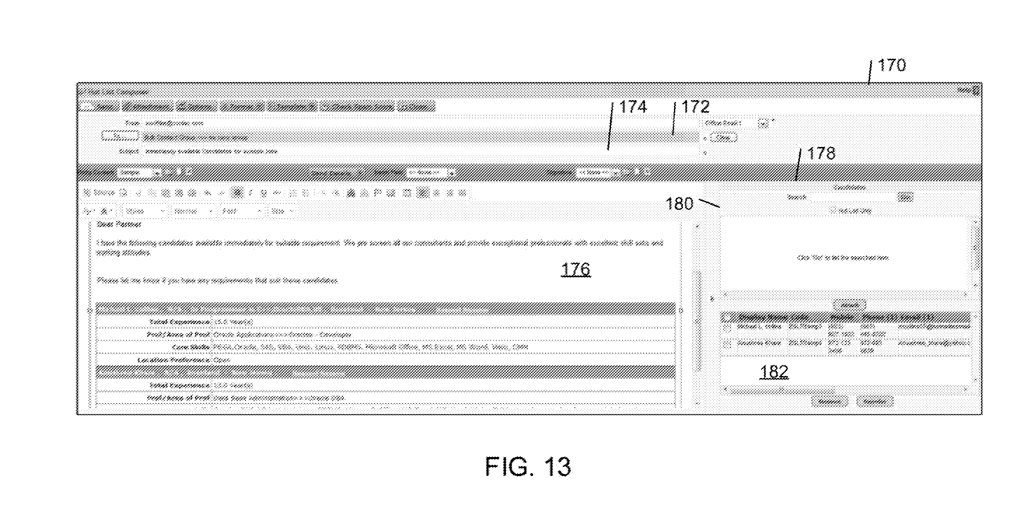

FIG. 12 shows an example of a Hot List interface 190 that allows the user to: search for available candidates in the recruiting information database 46 by entering search query terms in a search box and selecting a Search button 192; view the attributes of candidates in a list of candidates ordered according criteria selected by the user in dropdown lists 194, 196; and select one or more of the listed candidates by checking the checkboxes 198 associated with the listed candidates. After selecting one or more candidates, the user may select a Send Hot List button 200 to generate a hot list from the attributes of the selected candidates.

FIG. 13 shows an example of a Hot List Composer interface 170 that is generated in response to user selection of the Send Hot List button 200 in the Hot List interface 190. The Hot List Composer interface 170 allows the user to compose a hot list that can be sent to recipients designated by the user (e.g., recipients in a bulk mailing list). The Hot List List Composer interface 170 includes a recipients field 172 for receiving one or more target recipient electronic mail addresses, a subject field 174 for receiving a description of the subject of the electronic mail message, a message content section 176 that includes a message body, and a Candidates section 178 that includes a search pane 180 and an attachment pane 182. The client manager application 30 automatically pre-populates the message body with candidate details according to a selected one of a set of standard hotlist templates. The user is able to customize the message body by adding, for example, an introductory note to the target recipients. The attachment pane 182 displays the candidate lists that currently are associated with the electronic mail message. The search pane 180 allows the user to find and select one or more additional candidates for inclusion in the hot list.

E. Matching Requirements and Candidates

For each registered recruiter (i.e., member recruiter), the matching system application 40 matches the recruiter's hotlist candidates with received job requirements based on the tokens that are respectively associated with the job requirements.

As explained above, each token consists of (i) a set of mandatory matching fields (e.g., proficiency, location, and experience) that must be present in the requirements list that will be sent with the electronic mail message, and (ii) a set of predefined levels of matching precision (e.g., Normal, High, and Exact), where each matching precision level defines specific matching criteria for matching a respective one of the fields in the requirement with the corresponding hot list field characterizing a job candidate. In some examples, each matching field of a requirement is associated with (i) a respective set of one or more predefined requirement attribute values (e.g., a single value or a range of values) for each precision level, and (ii) a respective weight value. Based on the requirement attribute values and the weight values, the matching system application 40 determines an overall match score for each candidate as follows:
for each requirement matching field, compare the requirement attribute value with the value of the corresponding candidate attribute to obtain a respective field score, which depends on the matching precision level specified in the token for the requirement matching field;
for each field score, multiply the field score by the weight value associated with the corresponding field to obtain a weighted field score; and
sum the weighted field scores to obtain an overall match score for the candidate.

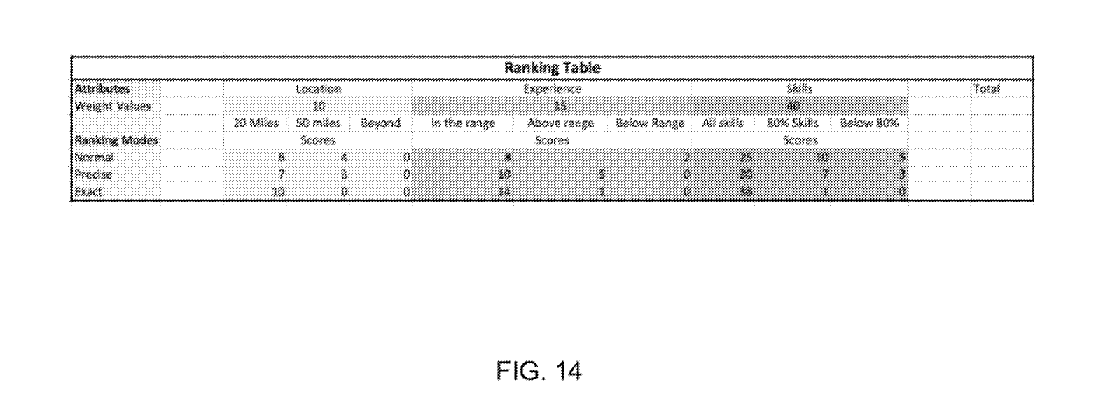

FIG. 14 shows an example of a Ranking Table 201 that contains the weight values for a set of three mandatory requirement matching fields (i.e., Location, Experience, and Skills) and a set of weighted field scores for each of the matching fields for each of three precision levels (i.e., Normal, High, and Exact). The matching system application 40 may use the Ranking Table 201 to rank candidates. For example, consider the case of a requirement that includes Location, Experience, and Skills attributes, with only the Location and Skills attributes designated as mandatory with an Exact matching precision level. In this case, the matching system application 40 determines a rank score for each candidate by summing the Exact precision level weighted scores for the Location and Skills attributes and the Normal precision level pre-weighted score for the Experience attribute. As an example, consider the candidates John and Susan who have the following candidate attribute values:

| | | | | Weighted |
|---|---|---|---|---|
| Candidate | | | | Field |
| Name | Attribute | Attribute Value | Precision Level | Score |
| John | Location | Within | Exact | 0 |
| | | 50 miles of | | |
| | | requirement | | |
| | | location | | |
| | Skills | Has 80% | Exact | 1 |
| | | of skills | | |
| | Experience | Has 8 years | Normal | 5 |
| | | experience | | |
| | | | MATCH SCORE | 6 |
| Susan | Location | Within 20 | Exact | 10 |
| | | miles of | | |
| | | requirement | | |
| | | location | | |
| | Skills | Has 80% | Exact | 1 |
| | | of skills | | |
| | Experience | Has 6 years | Normal | 8 |
| | | experience | | |
| | | | MATCH SCORE | 19 |

In this example, Susan has a higher match score and therefore is ranked higher than John.

After the matching system application 40 ranks the recruiter's hotlist candidates according to their respective overall match scores, it presents the ranked candidate list to the recruiter. The recruiter can then select a respective resume for each of one or more of the ranked candidates and send the selected resumes to the recruiter who sent the requirement.

F. Private Networks

In some examples, the information sharing service 24 also enables two or more registered recruiters (e.g., employees of different recruiting companies) to establish configurable private networks amongst themselves over which they can exchange recruiting information and match job requirements to candidates and vice versa with agreed upon levels of transparency that reflect their respective levels of comfort in exchanging information with each other.

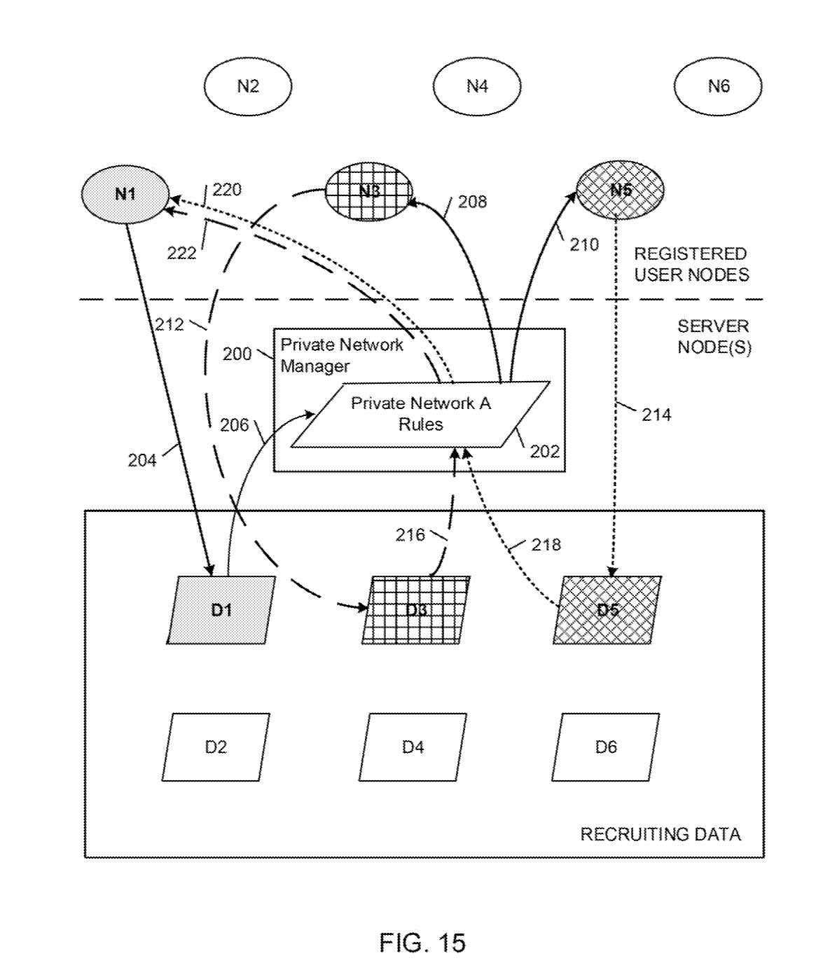

FIG. 15 shows an example of a private network manager application 200 that runs on the one or more server nodes 22 (see FIG. 1) to enable registered users operating respective client nodes N1-N6 to define configurable private networks amongst themselves that allows the registered users to exchange their respective sets of recruiting data D1-D6 with one another. In the illustrated example, the registered users of client nodes N1, N3, and N5 have established a private network (i.e., private network A) amongst themselves to exchange their respective sets of recruiting data D1, D3, and D5 with one another in accordance with a set of private network rules 202 (Private Network A Rules). The sets of recruiting data D1, D3, and D5 include requirements lists and hot lists that the registered users operating client nodes N1, N3, and N5 have uploaded or otherwise entered into the information sharing service 24 as described above (e.g., by interfacing the information sharing service 24 with their respective ATS or VMS systems). Instead of exchanging information by electronic mail, however, the registered users of client nodes N1, N3, and N5 have decided to make their respective sets of recruiting data visible to one another according to the private network rules 202. The private network rules 202 include: a list of the registered users (or groups of registered users) who are members of the private network, each of whom is identified by a unique identifier (e.g., their respective electronic mail addresses or other universally unique identifier (UUID)); and a set of transparency rules that define the level of detail with which the member users' recruiting data will be shared with one another.

FIG. 15 also shows an exemplary exchange of the recruiting data D1, D3, and D5 between the registered users of client nodes N1, N3, and N5. In this example, the user of node N1 uses a client web interface provided by an example of the client manager 38 (see FIG. 1) to direct the private network manager 200 to publish a requirement to the members of the private network A (step 204). In response, the private network manager 200 accesses the rules 202 of private network A to determine which of the other registered user nodes are able to receive the published requirement and the respective level of detail at which to present the requirement information (step 206). The private network manager 200 then publishes the requirement information to each of the member network nodes N3 and N5 at the determined level of detail (steps 208, 210). The matching system 40 (see FIG. 1) automatically determines candidates in the respective sets of recruiting data D3 and D5 that have attributes matching the published requirement information (steps 212, 214) and presents those candidates to the registered users of network nodes N3 and N5. The users of network nodes N3 and N5 then can use the private network manager 200 to submit respective hotlists of their matching candidates to the registered user of client node N1 (steps 216, 218, 220, 222).

In some examples, the information sharing service 24 provides one or more standard private network templates each of which defines a set of rules and transparency settings for a different respective type of private network. A group of registered users (or multiple groups of registered users) can select one of the standard private network templates from which to establish a private network. Examples of the types of rules in a standard private network template include: rules regarding publishing requirements and hot lists; rules regarding responding to published requirements and hot lists; and rules regarding authorization to modify recruiting data. Examples of the types of transparency settings in a standard private network template include: settings regarding which recruiting data will be visible to members of the private network; settings regarding which hot list database fields will be visible to members of the private network (e.g., in response to a published requirement); settings regarding which pipeline stage will be visible to members of the private network; setting regarding which details of a visible pipeline stage will be visible.

The information sharing service supports many different types of private network configurations, including one-to-many private networks and many-to-many private networks.

A typical one-to-many private network may be, for example, a consensual relationship formed between a given recruiter and others users (e.g., recruiters, candidates, or both recruiters and candidates), or a consensual relationship formed between a given candidate and a set of recruiters. In the first example, the given recruiter who forms the relationship may, for example, share his requirement information with a set of recruiters and/or candidates so they can respond with recruitment information of candidates, or share recruitment information of available candidates (hot list or bench candidates) with a set of recruiters and/or candidates so they can draw the recruitment information of candidates for their requirements. In the second example, the given candidate who forms the relationship may, for example, share his recruitment information with a set of recruiters. Examples of such one-to-many relationships include:
VMS where the requirement is shared by an end client with a set of chosen recruiters by making the requirement visible to those recruiters in its system so the chosen recruiters can “add/submit” suitable available candidates directly into the VMS system;
A recruiter sharing requirement information with a I list of a recruiter members by just making the requirement in his/her ATS visible to a set of recruiters so they can directly “add/Submit” recruitment information of available candidates;
A recruiter sharing available candidate information with a I list of a recruiter members by just making the available candidates in his/her ATS visible to a set of recruiters so they can directly “draw” recruitment information of available candidates;
A bulk mail list of a recruiter containing a list of email addresses of candidate members to broadcast requirements and Hot lists; and
A list of recruiters maintained by a candidate with whom he shares his recruitment information.

A typical many-to-many private network may be, for example, a consensual relationship formed among recruiters. Examples of such relationships include:
Recruiters belonging to a private network mutually making chosen requirements visible to the rest of the private network members so they can directly “add/submit” candidates to the requirement;
Recruiters belonging to a private network mutually making chosen available candidates visible to the rest of the private network members so they can directly “draw” candidates to their suitable requirements; and
Both of the above in the same private network.

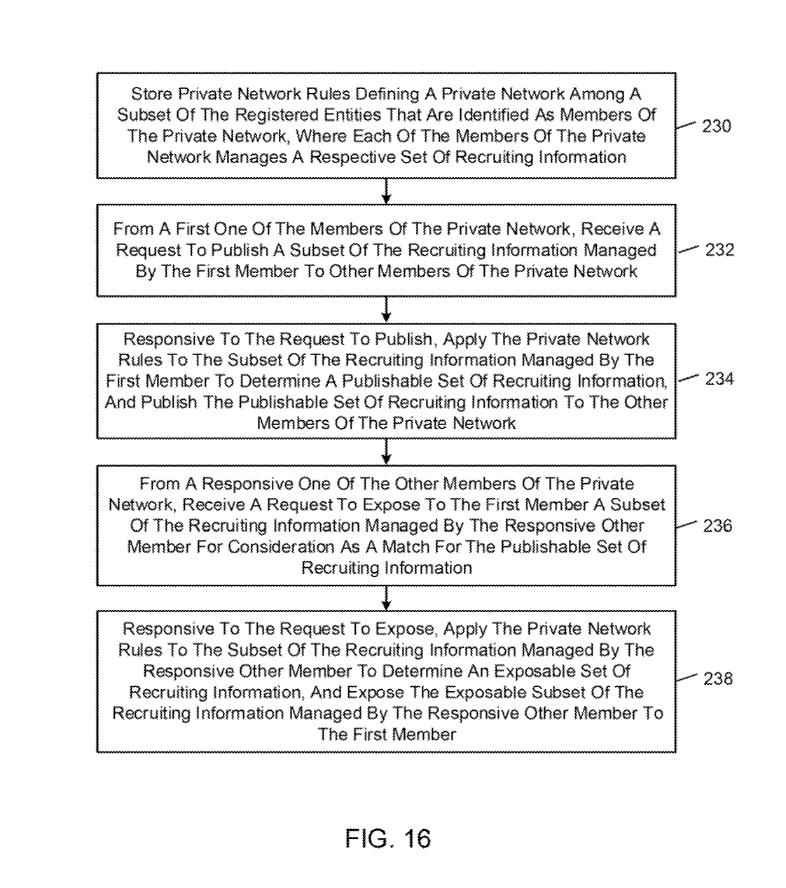

FIG. 16 shows an example of a method by which the information sharing service 24 enables members of a private network to exchange recruiting information amongst themselves. In accordance with this method, the information sharing service 24 stores private network rules defining a private network among a subset of the registered entities that are identified as members of the private network, where each of the members of the private network manages a respective set of recruiting information (FIG. 16, block 230). From a first one of the members of the private network, the information sharing service 24 receives a request to publish a subset of the recruiting information managed by the first member to other members of the private network (FIG. 16, block 232). Responsive to the request to publish, the information sharing service 24 applies the private network rules to the subset of the recruiting information managed by the first member to determine a publishable set of recruiting information, and publishes the publishable set of recruiting information to the other members of the private network (FIG. 16, block 234). From a responsive one of the other members of the private network, the information sharing service 24 receives a request to expose to the first member a subset of the recruiting information managed by the responsive other member for consideration as a match for the publishable set of recruiting information (FIG. 16, block 236). Responsive to the request to expose, the information sharing service 24 applies the private network rules to the subset of the recruiting information managed by the responsive other member to determine an exposable set of recruiting information, and exposes the exposable subset of the recruiting information managed by the responsive other member to the first member (FIG. 16, block 238).

In some examples, a member of a private network publishes a job requirement to the other members of the private network who, in turn, are able to reply to the job requirement with a hotlist of one or more matching job candidates. That is, in the method shown in FIG. 16, the subset of the recruiting information managed by the first member are attributes of a job requirement for a job, and the subset of the recruiting information managed by the responsive other member are attributes of a job candidate. The attributes of the job requirement are determined by applying the private network rules to the subset of the recruiting information managed by the first member, and the attributes of the job requirement are determined by applying the private network rules to the subset of the recruiting information managed by the responsive other member. In these examples, prior to receiving the request to expose (FIG. 16, block 236), the information sharing service 24 typically matches the job candidate to the job requirement based on a comparison of attributes of the job requirement with corresponding attributes of the job candidate, and then presents the job candidate to the responsive other member as a potential match for the job requirement.

In other examples, a member of a private network publishes a hotlist of one or more job candidates to other members of the private network who, in turn, are able to identify one or more of their respective job requirements that match respective ones of the candidates in the published hotlist. That is, in the method shown in FIG. 16, the subset of the recruiting information managed by the first member are attributes of at least one job candidate, and the subset of the recruiting information managed by the responsive other member are attributes of a job requirement for a job. The attributes of the job requirement are determined by applying the private network rules to the subset of the recruiting information managed by the responsive other member, and the attributes of the job requirement are determined by applying the private network rules to the subset of the recruiting information managed by the first member. In these examples, prior to receiving the request to expose (FIG. 16, block 236), the information sharing service 24 typically matches the job candidate to the job requirement based on a comparison of attributes of the job requirement with corresponding attributes of the job candidate, and presenting the job candidate to the responsive other member as a potential match for the job requirement.

In addition to sharing job requirements and candidate hotlists, the members of a private network also are able to share information regarding a candidate's progress through job candidate evaluation pipelines for a job requirement with a level of transparency that is defined by the private network rules. Each a job candidate evaluation pipeline typically includes several evaluation stages through which candidates for the job pass before being accepted for the job.

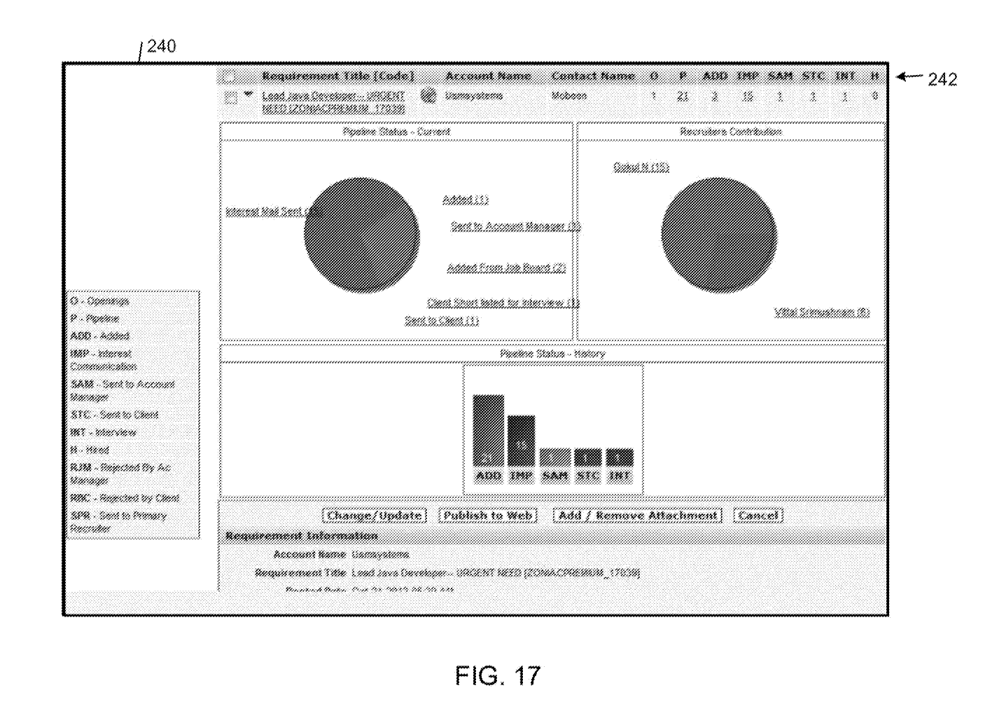

FIG. 17 shows an example of a graphical user interface 240 that displays information describing the progress of job candidates through a job candidate evaluation pipeline for a job requirement entitled “Lead Java Developer.” In this example, the graphical user interface 240 shows the following pipeline information 242: the number of openings (O); the number of candidates in the pipeline (P); the number of candidates recently added to the pipeline (ADD); the number of candidates to whom an interest communication has been sent (IMP); the number of candidates whose resume has been send to an account manager (SAM); the number of candidates whose resume has been sent to a client (STC); the number of candidates who have been set up to be interviewed for the job (INT); and the number of candidates who have been hired for the job (H). In a typical example, the member of the private network who manages the job requirement is able to view the pipeline progress for all the candidates that under evaluation, whereas each of the members of the private network who have submitted candidates for the job is able to view the pipeline progress information for only those candidates that they submitted.

As mentioned above, there are examples in which a member of a private network publishes a job requirement to the other members of the private network who, in turn, are able to reply to the job requirement with a hotlist of one or more matching job candidates. In these examples, with respect to the method of FIG. 16, the information sharing service 24 establishes a job candidate evaluation pipeline that includes evaluation stages through which candidates for the job pass before being accepted for the job. From the first member, the information sharing service 24 receives a request to add the job candidate to the job candidate pipeline. Responsive to the request to add, the information sharing service 24 adds the job candidate to the job candidate pipeline, tracks the job candidate's progress through the job candidate pipeline, displays the job candidate's progress through the job candidate pipeline to the first member, ascertains revealable candidate progress information based on application of the private network rules to information describing the job candidate's progress, and reveals the revealable candidate progress information to the responsive other member. In some examples, the process of ascertaining revealable candidate progress information involves identifying which of the stages of the job candidate pipeline are revealable in accordance with the private network rules, determining the job candidate's current position in the job candidate pipeline, and revealing the job candidates current position only if it coincides with an identified one of the stages of the job candidate pipeline.

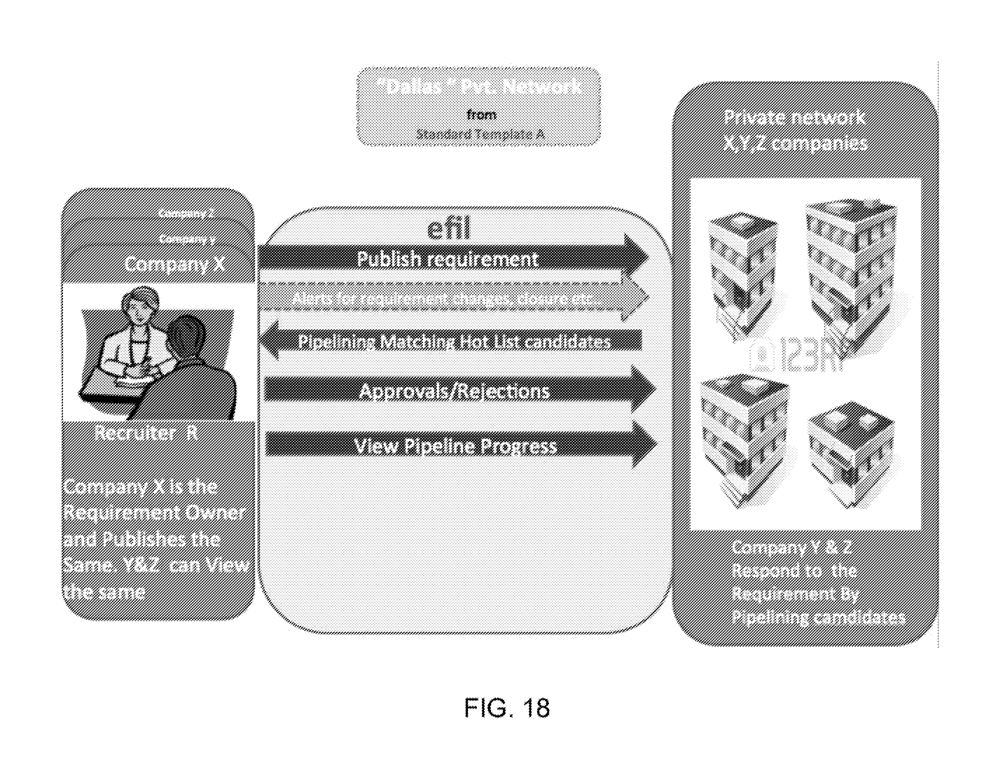

FIG. 18 shows an example of a private network (“Dallas”) that is that is established between recruiting companies X, Y, and Z from a standard private network template A. The Dallas private network provides the following: visibility of chosen requirements to partners within the private network through publishing; matching hotlist candidates to requirements by “receiving” partners within the private network; direct pipelining (add stage) into requirements by “receiving” partners within the private network; and visibility of progress in pipeline to “receiving” partners of their own candidates. The Dallas private network includes the following types of rules and transparency settings:

Rules
Recruiter of Company X publish requirements to other recruitment Companies Y and Z
Any changes made to the Requirement after publishing will reach Companies Y and Z via alerts
Companies Y and Z match their hotlist Candidates for requirements received from Company X
Companies Y and Z recruiters add matched candidates to Company X's requirement. Companies Y and Z view their candidates in the pipeline
Company X moves all candidates, including its own, along the pipeline
Companies Y and Z will view pipeline progress from Company X's for their respective resumes only
Company X views pipeline progress of all pipelined candidates
Companies Y and Z can only view but not modify the pipeline.

Transparency Settings
Which requirement data will be visible to Companies Y and Z
Which hotlists database fields will be transferred during addition to pipeline
Which Pipeline Stage Companies Y and Z can view
What Pipeline Stage details' Companies Y and Z can view, for example:
   Interview details
   Feedback

As mentioned above, there also are examples in which a member of a private network publishes a hotlist of one or more job candidates to other members of the private network who, in turn, are able to identify one or more of their respective job requirements that match respective ones of the candidates in the published hotlist. In these examples, with respect to the method of FIG. 16, the information sharing service 24 establishes a job candidate evaluation pipeline that includes evaluation stages through which candidates for the job pass before being accepted for the job. From the responsive other member, the information sharing service 24 receives a request to add the job candidate to the job candidate pipeline. Responsive to the request to add, the information sharing service 24 adds the job candidate to the job candidate pipeline, tracks the job candidate's progress through the job candidate pipeline, displays the job candidate's progress through the job candidate pipeline to the responsive other member, ascertains revealable candidate progress information based on application of the private network rules to information describing the job candidate's progress, and reveals the revealable candidate progress information to the first member. In some examples, the process of ascertaining revealable candidate progress information involves identifying which of the stages of the job candidate pipeline are revealable in accordance with the private network rules, determining the job candidate's current position in the job candidate pipeline, and revealing the job candidates current position only if it coincides with an identified one of the stages of the job candidate pipeline.

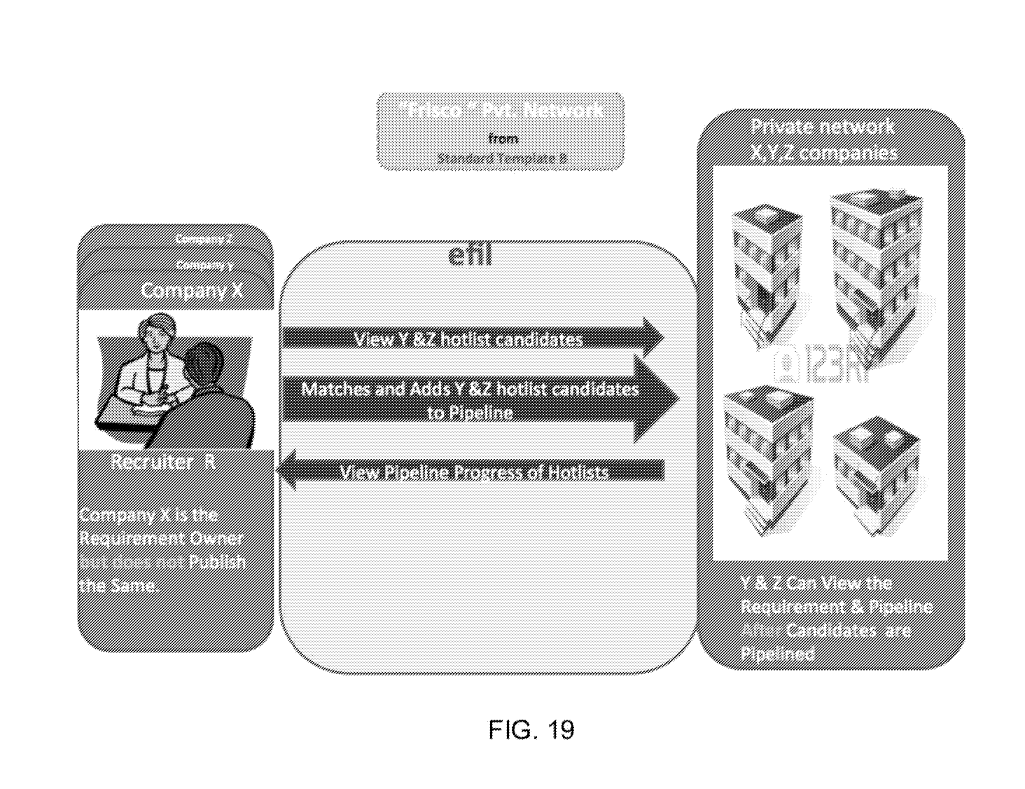

FIG. 19 shows an example of a private network (“Frisco”) that is that is established between recruiting companies X, Y, and Z from a standard private network template B. The Frisco private network provides the following: visibility to the “requirement owner” into chosen hot list candidates (of each partner) made available to the network by all partners within the private network; the requirement owner matching candidates from the above hot lists from partners within the private network; the requirement owner pipelining candidates directly from partners within the private network; visibility of progress in pipeline to partners of their own candidates. The Frisco private network includes the following types of rules and transparency settings:

Rules
Companies X, Y, and Z make a subset of hotlist candidates available to the members of the network. Each of the companies can view the available candidates of the rest of the members' available candidates
Recruiter of Company X establishes a requirement but does not Publish it.
X matches available candidates of Companies Y and Z and also Company X with requirement.
Company X adds a subset of the matched candidates to the pipeline.
Companies Y and Z will now be able to see the Requirement and the pipeline of their own candidates
Company X moves all candidates, including its own, along the pipeline
Companies Y and Z will view pipeline progress for their respective resumes only
Company X views pipeline progress of all pipelined candidates
Companies Y and Z can only view but not modify Company X's data.

Transparency Settings
Which requirement data will be visible to Companies Y and Z
Which hotlists database fields will X be able to see and be transfer during addition to pipeline
Which Pipeline Stage Companies Y and Z can view
What Pipeline Stage details Companies Y and Z can view, for example:
   Interview details
   Feedback

### III. CONCLUSION

Other embodiments are within the scope of the claims.

1. A method of sharing recruiting information in a network communication environment comprising a network service implemented by at least one physical server network node supporting communications between physical network nodes of respective entities registered with the network service, comprising
by the network service:
storing private network rules defining a private network among a subset of the registered entities that are identified as members of the private network, wherein each of the members of the private network manages a respective set of recruiting information;
from a first one of the members of the private network, receiving a request to publish a subset of the recruiting information managed by the first member to other members of the private network;
responsive to the request to publish, applying the private network rules to the subset of the recruiting information managed by the first member to determine a publishable set of recruiting information, and publishing the publishable set of recruiting information to the other members of the private network;
from a responsive one of the other members of the private network, receiving a request to expose to the first member a subset of the recruiting information managed by the responsive other member for consideration as a match for the publishable set of recruiting information; and
responsive to the request to expose, applying the private network rules to the subset of the recruiting information managed by the responsive other member to determine an exposable set of recruiting information, and exposing the exposable subset of the recruiting information managed by the responsive other member to the first member.

2. The method of claim 1, wherein the subset of the recruiting information managed by the first member are attributes of a job requirement for a job, and the subset of the recruiting information managed by the responsive other member are attributes of a job candidate.

3. The method of claim 2, further comprising by the network service:
prior to receiving the request to expose, matching the job candidate to the job requirement based on a comparison of attributes of the job requirement with corresponding attributes of the job candidate, and presenting the job candidate to the responsive other member as a potential match for the job requirement.

4. The method of claim 2, wherein the attributes of the job requirement are determined by applying the private network rules to the subset of the recruiting information managed by the first member.

5. The method of claim 2, wherein the attributes of the job requirement are determined by applying the private network rules to the subset of the recruiting information managed by the responsive other member.

6. The method of claim 2, further comprising by the network service:
establishing a job candidate evaluation pipeline comprising evaluation stages through which candidates for the job pass before being accepted for the job;
from the first member, receiving a request to add the job candidate to the job candidate pipeline; and
responsive to the request to add,
adding the job candidate to the job candidate pipeline,
tracking the job candidate's progress through the job candidate pipeline,
displaying the job candidate's progress through the job candidate pipeline to the first member,
ascertaining revealable candidate progress information based on application of the private network rules to information describing the job candidate's progress, and
revealing the revealable candidate progress information to the responsive other member.

7. The method of claim 6, wherein the ascertaining comprises identifying which of the stages of the job candidate pipeline are revealable in accordance with the private network rules, determining the job candidate's current position in the job candidate pipeline, and revealing the job candidates current position only if it coincides with an identified one of the stages of the job candidate pipeline.

8. The method of claim 6, further comprising, for each of one or more other responsive ones of the other members, repeating the receiving of a request to expose, the applying, and the exposing with respect to attributes of one or more other job candidates managed by the other responsive ones of the other members;
from the first member, receiving additional requests to add the job candidates exposed by the other members of the private network to the job candidate pipeline; and
responsive to the additional requests to add, repeating the adding, the tracking, the displaying, the ascertaining, and the revealing for each of the other job candidates, wherein each of the revealable candidate progress information is accessible only by the respective managing one of the other responsive ones of the other members.

9. The method of claim 1, further comprising by the network service:
responsive to a request from the first member, modifying the recruiting information managed by the first member; and
responsive to a determination that modification of the subset of the recruiting information published to the other members is needed to reflect the modification of the recruiting information managed by the first member, automatically modifying the published subset of recruiting information and publishing the modified subset of recruiting information to the other members of the private network.

10. The method of claim 1, further comprising by the network service:
from a particular one of the other members, receiving a request to modify the published subset of recruiting information managed by the first member,
responsive to the request to modify,
determining whether the private network rules allow the particular other member to modify one or more elements of the published subset of recruiting information,
in response to a determination that the particular other member is allowed to modify elements of the published subset of recruiting information, modifying one or more of the modifiable elements of the published subset of the recruiting information and publishing the modified subset of the recruiting information to the other members of the private network.

11. The method of claim 1, wherein the subset of the recruiting information managed by the first member are attributes of at least one job candidate, and the subset of the recruiting information managed by the responsive other member are attributes of a job requirement for a job.

12. The method of claim 11, further comprising by the network service:
prior to receiving the request to expose, matching the job candidate to the job requirement based on a comparison of attributes of the job requirement with corresponding attributes of the job candidate, and presenting the job candidate to the responsive other member as a potential match for the job requirement.

13. The method of claim 11, wherein the attributes of the job requirement are determined by applying the private network rules to the subset of the recruiting information managed by the responsive other member.

14. The method of claim 11, wherein the attributes of the job requirement are determined by applying the private network rules to the subset of the recruiting information managed by the first member.

15. The method of claim 11, further comprising by the network service:
establishing a job candidate evaluation pipeline comprising evaluation stages through which candidates for the job pass before being accepted for the job;
from the responsive other member, receiving a request to add the job candidate to the job candidate pipeline; and
responsive to the request to add,
adding the job candidate to the job candidate pipeline,
tracking the job candidate's progress through the job candidate pipeline,
displaying the job candidate's progress through the job candidate pipeline to the responsive other member,
ascertaining revealable candidate progress information based on application of the private network rules to information describing the job candidate's progress, and
revealing the revealable candidate progress information to the first member.

16. The method of claim 1, wherein one or more of the entities are individual users who interact with the network service.

17. The method of claim 1, wherein one or more of the entities are recruiting companies each of which comprises a respective set of one or more users who interact with the network service.

18. The method of claim 1, further comprising by the network service:
managing storage of the recruiting information for one or more of the members of the private network in physical memory; and
for each of one or more of the members of the private network, retrieving the respective recruiting information through an interface with an external applicant tracking system of the member.

19. Apparatus supporting communications between physical network nodes of respective entities registered with the network service, the apparatus, comprising
a non-transitory processor-readable medium storing processor-readable instructions, and
a processor coupled to the processor-readable medium, operable to execute the instructions, and based at least in part on the execution of the instructions operable to perform operations comprising:
storing private network rules defining a private network among a subset of the registered entities that are identified as members of the private network, wherein each of the members of the private network manages a respective set of recruiting information;
from a first one of the members of the private network, receiving a request to publish a subset of the recruiting information managed by the first member to other members of the private network;
responsive to the request to publish, applying the private network rules to the subset of the recruiting information managed by the first member to determine a publishable set of recruiting information, and publishing the publishable set of recruiting information to the other members of the private network;
from a responsive one of the other members of the private network, receiving a request to expose to the first member a subset of the recruiting information managed by the responsive other member for consideration as a match for the publishable set of recruiting information; and
responsive to the request to expose, applying the private network rules to the subset of the recruiting information managed by the responsive other member to determine an exposable set of recruiting information, and exposing the exposable subset of the recruiting information managed by the responsive other member to the first member.

20. At least one computer-readable medium having processor-readable program code embodied therein, the processor-readable program code adapted to be executed at least one physical server network node supporting communications between physical network nodes of respective entities registered with the network service, wherein execution of the processor-readable program code by the at least one physical server network node causes the at least one physical server network node to perform operations comprising:
storing private network rules defining a private network among a subset of the registered entities that are identified as members of the private network, wherein each of the members of the private network manages a respective set of recruiting information;
from a first one of the members of the private network, receiving a request to publish a subset of the recruiting information managed by the first member to other members of the private network;
responsive to the request to publish, applying the private network rules to the subset of the recruiting information managed by the first member to determine a publishable set of recruiting information, and publishing the publishable set of recruiting information to the other members of the private network;
from a responsive one of the other members of the private network, receiving a request to expose to the first member a subset of the recruiting information managed by the responsive other member for consideration as a match for the publishable set of recruiting information; and
responsive to the request to expose, applying the private network rules to the subset of the recruiting information managed by the responsive other member to determine an exposable set of recruiting information, and exposing the exposable subset of the recruiting information managed by the responsive other member to the first member.
